(19) United States
(12) Patent Application Publication
(10) Pub. No.: US 2025/0078462 A1
(43) Pub. Date: Mar. 6, 2025

(54) SYSTEM AND METHOD TRANSFORMING VISUAL COMMONSENSE REASONING AS COMMONSENSE REASONING AND VISUAL RECOGNITION WITH LARGE LANGUAGE MODELS

(71) Applicant: Honda Motor Co., Ltd., Tokyo (JP)

(72) Inventors: Kaiwen ZHOU, Sunnyvale, CA (US); Kwonjoon LEE, San Jose, CA (US); Teruhisa MISU, San Jose, CA (US)

(73) Assignee: Honda Motor Co., Ltd., Tokyo (JP)

(21) Appl. No.: 18/583,149

(22) Filed: Feb. 21, 2024

Related U.S. Application Data
(60) Provisional application No. 63/536,670, filed on Sep. 5, 2023.

(51) Int. Cl. G06V 10/764; G06V 10/776

(52) U.S. Cl. CPC G06V 10/764; G06V 10/776

(57) ABSTRACT

A method for visual commonsense reasoning (VCR) to infer information from an image is provided. The method may separate a VCR matter into a visual commonsense understanding (VCU) matter and a visual commonsense inference (VCI) matter. The method may provide a visual content of the image using a VCU model. The method may provide conclusions based on content of the image using a VCI model.

### RELATED APPLICATIONS

This patent application is related to U.S. Provisional Application Ser. No. 63/536,670 filed Sep. 5, 2023, entitled “SYSTEM AND METHOD TRANSFORMING VISUAL COMMONSENSE REASONING AS COMMONSENSE REASONING AND VISUAL RECOGNITION WITH LARGE LANGUAGE MODELS”, in the names of the same inventors which is incorporated herein by reference in its entirety. The present patent application claims the benefit under 35 U.S.C § 119(e) of the aforementioned provisional application.

### BACKGROUND

Visual Commonsense Reasoning (VCR) processes may be used to interpret visual scenes. VCR generally aims at answering a textual question regarding an image, followed by the rationale prediction for the preceding answering. VCR generally requires machines to utilize commonsense knowledge for drawing novel conclusions or providing explanations that go beyond the explicit information present in the image. To solve these problems, existing methods may treat VCR as an image-text alignment task between the image content and candidate commonsense inferences. However, these approaches may lack explicit modeling of the underlying reasoning steps which may limit their ability to generalize beyond the training data distribution.

Recent methods have leveraged large language models (LLMs) for VCR problems. However, these methods may have several drawbacks. Firstly, these methods may require supervised training or fine-tuning on each specific dataset. Since different visual commonsense reasoning datasets may have different focuses and data distributions (e.g., human-centric reasoning and reasoning in general topics), the trained models may struggle to generalize effectively to different datasets. Secondly, current methods on different datasets may be based either on supervised visual language models (VLMs) or combine VLMs (fine-tuned on in-domain VCR datasets) with LLMs. However, presently there is no comprehensive discussion on how VLMs and LLMs compare in the context of VCR problems and how to best harness their complementary capabilities.

Limitations and disadvantages of conventional and traditional approaches will become apparent to one of skill in the art, through comparison of described method with some aspects of the present disclosure, as set forth in the remainder of the present application and with reference to the drawings.

### SUMMARY

According to an embodiment of the disclosure, a method for visual commonsense reasoning (VCR) to infer information from an image is provided. The method may separate a VCR matter into a visual commonsense understanding (VCU) matter and a visual commonsense inference (VCI) matter. The method may provide a visual content of the image using a VCU model. The method may further provide conclusions based on content of the image using a VCI model.

According to another embodiment of the disclosure, method for visual commonsense reasoning (VCR) to infer information from an image, the method implemented using a control system including a processor communicatively coupled to a memory device is provided. The method may separate a VCR matter into a visual commonsense understanding (VCU) matter and a visual commonsense inference (VCI) matter. The method may infer concepts of the image using a VCU model, wherein the VCU model recognizes visual patterns in the image and combines characteristics and particulars from the image to infer the concepts from the image. The method may provide conclusions based on content of the image using a VCI model. The method may further use large language models (LLMs) as matter classifiers for the VCU matter and the VCI matter. The method may direct VLMs based on the matter classifiers using visual language models (VLMs) commanders. The method may use pre-trained VLMs for visual recognition and understanding of the image.

According to another embodiment of the disclosure, a method for visual commonsense reasoning (VCR) to infer information from an image is provided. The method may separate a VCR matter into a visual commonsense understanding (VCU) matter and a visual commonsense inference (VCI) matter. The method may infer concepts of the image using a VCU model, wherein the VCU model recognizes visual patterns in the image and combines characteristics and particulars from the image to infer the concepts from the image. The method may provide conclusions based on content of the image using a VCI model. The method may evaluate a plausibility of an inference by evaluating the inference using non-visual commonsense knowledge to perform reasoning based on visual observations derived from the image by the VCI model. The method may further form an initial perception result of a plausibility of the inference using large language models (LLMs), wherein the LLMs takes the initial perception result of the inference as an input to evaluate potential answer candidates when the initial perception result of the inference is below a predetermined level. The method may form a commonsense inference using visual factors from the image by the LLMs when the initial perception result of the inference is below a predetermined level. The method may form a new perception result using a vision-and-language model (VLM). The method may return the new perception result back to the LLM. The method may re-evaluate the potential answer candidates by the LLM based on the new perception results.

### BRIEF DESCRIPTION OF THE DRAWINGS

FIG. 1 is a block diagram of an exemplary visual commonsense reasoning (VCR) model, in accordance with an embodiment of the disclosure;

FIG. 2 shows a table that illustrates the effects of problem categorization and clue generation of an exemplary VCR model, in accordance with an embodiment of the disclosure;

FIG. 3 is a block diagram of an exemplary VCR model, in accordance with an embodiment of the disclosure;

FIG. 4 shows exemplary prompt examples in accordance with an embodiment of the disclosure;

FIG. 5 shows a table that compares other methods to an exemplary VCR model on VCR Q→A task, in accordance with an embodiment of the disclosure;

FIG. 6 shows a table that compares other methods to an exemplary VCR model on A-OKVQA Q→A datasets, in accordance with an embodiment of the disclosure; and

FIG. 7 illustrates qualitative examples of an exemplary VCR model, in accordance with an embodiment of the disclosure.

The foregoing summary, as well as the following detailed description of the present disclosure, is better understood when read in conjunction with the appended drawings. For the purpose of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

The present disclosure analyzes the synergistic capabilities of pre-trained vision-and-language models (VLMs) and large language models (LLMs) for visual commonsense reasoning (VCR). VCR may be categorized into visual commonsense understanding (VCU) and visual commonsense inference (VCI). For VCU, which may involve perceiving the literal visual content, pre-trained VLMs exhibit strong cross-dataset generalization. On the other hand, in VCI, where the goal is to infer conclusions beyond image content, VLMs may face issues. It has been found that a baseline where VLMs provide perception results (image captions) to LLMs may lead to improved performance on VCI. However, VLMs' passive perception may miss context information, leading to incorrect or uncertain reasoning by LLMs. To mitigate this issue, the present system and method suggest a collaborative approach where LLMs, when uncertain about their reasoning, actively directs VLMs to concentrate on and gather relevant visual elements to support potential commonsense inferences. In the present system and method, pre-trained LLMs may serve as problem classifiers to analyze the problem category, VLM commanders may leverage VLMs differently based on the problem classification, and visual commonsense reasoners may answer the question.

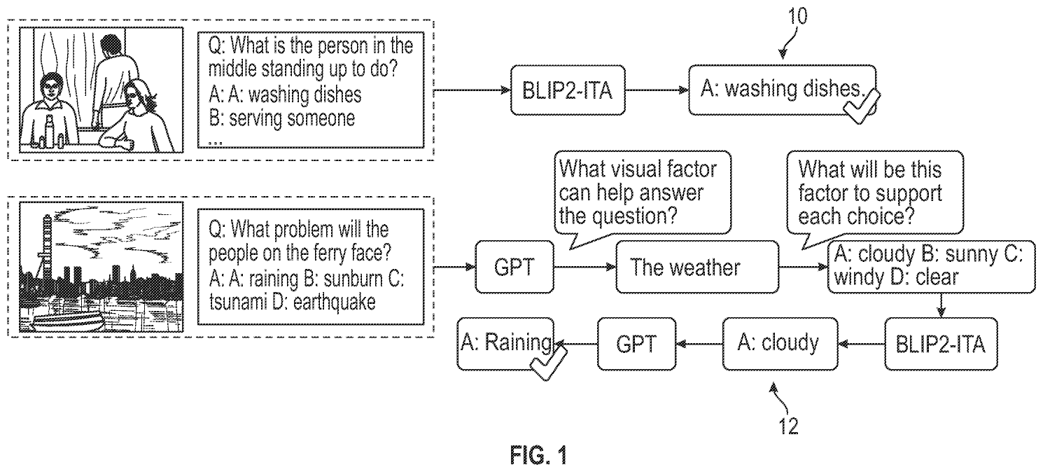

Referring to FIG. 1, visual commonsense reasoning (VCR) may be categorized into visual commonsense understanding (VCU) 10 and visual commonsense inference (VCI) 12. VCU 10 and VCI 12 may require different model capabilities. For example, VCU 10 may require the model to understand high-level concepts and attributes such as actions, events, relations, etc., which pre-trained visual language models (VLMs) may achieve via image-text alignment (ITA). VCI 12 may require the model to generate conclusions or explanations based on input image. Overlooking visual clues may result in erroneous conclusions. LLMs may steer VLMs in discovering vital visual cues for answer support. The LLM may employ the top ITA-scored visual clue (e.g., “It is cloudy.”) to perform commonsense inference.

Thus, the issues with VCR may be categorized into two sub-issues—VCU issues and VCI issues. The VCU issue may require a model to recognize various low-level visual patterns and then understand high-level concepts like actions, events, and relations in the image. The VCI issue may require the model to deduce conclusions or form explanations, likely to be true, based on visual observation. It may require a broad array of commonsense knowledge about the world, including cause-and-effect relationships, intentions, and mental states. As prior work does not adopt this categorization, the present system and method may instruct LLMs to classify these tasks, providing problem type descriptions along with a limited number of manually annotated in-context samples. Based on the categorization, the performance of the VLMs and LLMs (equipped with image captions from VLMs) may be assessed on VCU 10 and VCI 12.

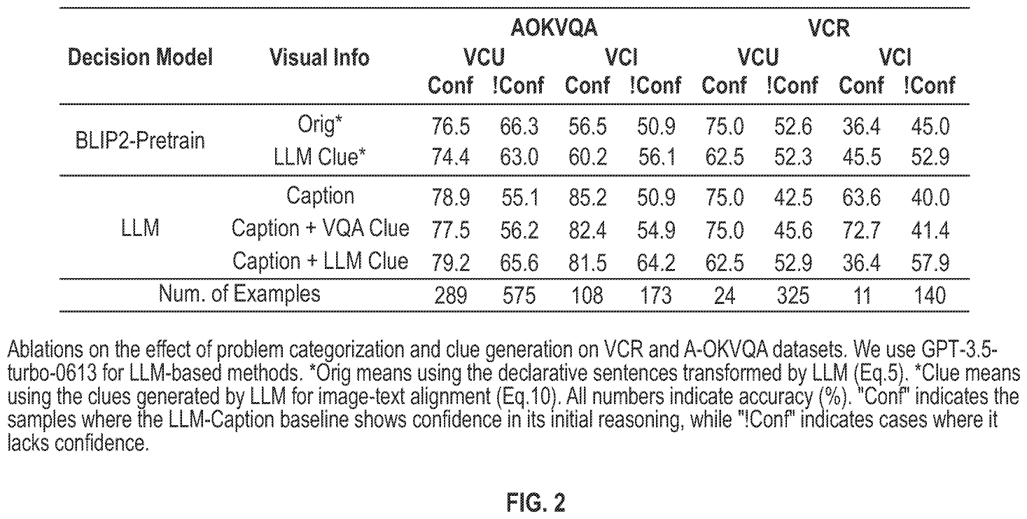

Referring to FIG. 2, testing has shown that VLMs may perform slightly better in VCU tasks, while also being more efficient. Conversely, in VCI tasks, LLMs may outperform VLMs in most cases. This observation aligns with previous findings indicating that LLMs may excel in text-based commonsense benchmarks.

Image captions provided by VLMs may lack crucial contextual information necessary for answering questions. This may pose a particular challenge for commonsense inference problems, as inferences may often be defeasible given additional context. To illustrate this issue, consider the example depicted in FIG. 1, VCI 12. The caption may capture the main content of the image, including the buildings, river, and bridge, resulting in a determination of “D: earthquake” as an answer by VCI 12. However, upon closer examination of the cloudy weather, the determination may be revised by VCI 12 to “A: raining.” Existing perception modules, including VLMs, operate in a feed-forward manner and cannot adjust their perception based on a high-level understanding or inference. To address this, the present system and method instruct LLMs to intervene with VLMs in cases where they are uncertain about inference, typically indicative of a lack of sufficient visual evidence. This intervention may guide VLMs to focus on specific visual factors, such as weather or emotions, to support commonsense inferences.

In accordance with an embodiment, the present system and method may employ the following components: (1) LLMs may function as problem type classifiers (VCU and VCI), VLM commanders may be used for directing VLMs based on problem classification, and visual commonsense reasoners to harness their extensive world knowledge and reasoning capabilities. (2) Pre-trained VLMs may be responsible for visual recognition and understanding. Communication between LLMs and VLMs may occur through text, such as image captions, as they may be universal medium for all existing models. On VCR and augmented outside knowledge visual question answering (A-OKVQA), the present system and method may achieve state-of-the-art results among methods without supervised in-domain fine-tuning, unlike present systems and methods.

### Visual Commonsense Reasoning

Visual Commonsense Reasoning (VCR) may be thought of as an emerging research area that may aim to endow artificial intelligence (AI) models with a human-like understanding and reasoning of visual scenes, beyond what may be directly observed. The objective may be to understand high-level concepts such as events, relations, and actions and infer unobservable aspects such as intents, causal relationships, and future actions, requiring the integration of visual perception, understanding, and commonsense knowledge. The VCR task was introduced where models may answer a question about an image, given a set of four possible answers. Further, more datasets may have been provided and focused on more types of reasoning. Most state-of-the-art methods may treat VCR as an image-text alignment problem, where they encode the commonsense inference and the visual input, then predict the alignment score of the image-text pair via a classification head or image-text.

Although achieving impressive performance, the generalizability of these methods may be limited by supervised training. Recently, several works may have leveraged large language models for visual commonsense reasoning. However, these methods may require some VLMs trained on the datasets to provide visual information. Others may use LLMs to decompose the main problem and use VQA models to acquire visual information. The present system and method may systematically study the visual commonsense reasoning issue and better leverages the strength of different pre-trained VLMs and the reasoning abilities of LLMs, which may be generalized to different visual commonsense reasoning datasets.

### Large Language Models for Vision-and-Language Tasks

Benefiting from the rich knowledge in LLMs, LLMs may have been used for various vision-and-language tasks in a zero-shot or few-shot manner. Some methods may have leveraged LLMs for OK-VQA task by feeding the caption, question, candidate answers by VQA models, etc. to GPT3 models, and prompt the GPT model to answer the question with its pre-trained knowledge. It has been proposed that LLMs may be used with image descriptors for video-language tasks. More recently, with the discovery of LLMs' tool using ability, LLMs may have been equipped with various visual tools and achieved significant performance in Compositional Visual Question Answering, Science Question Answering tasks. Different from these works, the present system and method studies a more complex and challenging task with different levels of reasoning, including requiring reasoning beyond direct image observation. In the present system and method, the LLMs may perform reasoning for problem classification, visual information query, and commonsense reasoning.

### Visual Commonsense Reasoning

### 1. Visual Commonsense Understanding

The visual commonsense understanding (VCU) problem may require the model to judge if a text T describing a concept or an attribute aligns with the image I:

$$e = F ( I , T ) \qquad ( 1 )$$

wherein e stands for evaluation of T by model F. To answer these questions, the model may need to be able to map the low-level visual observations, such as objects and spatial relations to high-level visual concepts and attributes, such as actions, events, and relations in the image.

### 2. Visual Commonsense Inference

The visual commonsense inference (VCI) problem may require the model to evaluate the plausibility of an inference about the image. Evaluating these inferences T may need some non-visual commonsense knowledge to perform reasoning based on some visual observations {oᵢ} derived from the image:

$$e = F ( \{ {o}_{i} \} , T ) \qquad ( 2 )$$

Here, oᵢ may be low-level visual observations or high-level visual commonsense understanding. Examples of commonsense knowledge may be the purpose of an object, people's opinions about an object, potential future events, etc.

### 3. Visual Commonsense Reasoning Formulation

Both categories of visual commonsense reasoning tasks may share a common formulation. In visual commonsense reasoning, the input may consist of two parts: an image denoted as I and a multiple-choice question input represented as q, cᵢ, wherein q corresponds to the question, and cᵢ stands for the i-th answer choice. The model may choose a choice cᵢ that is most likely to be true based on the image I.

### Method

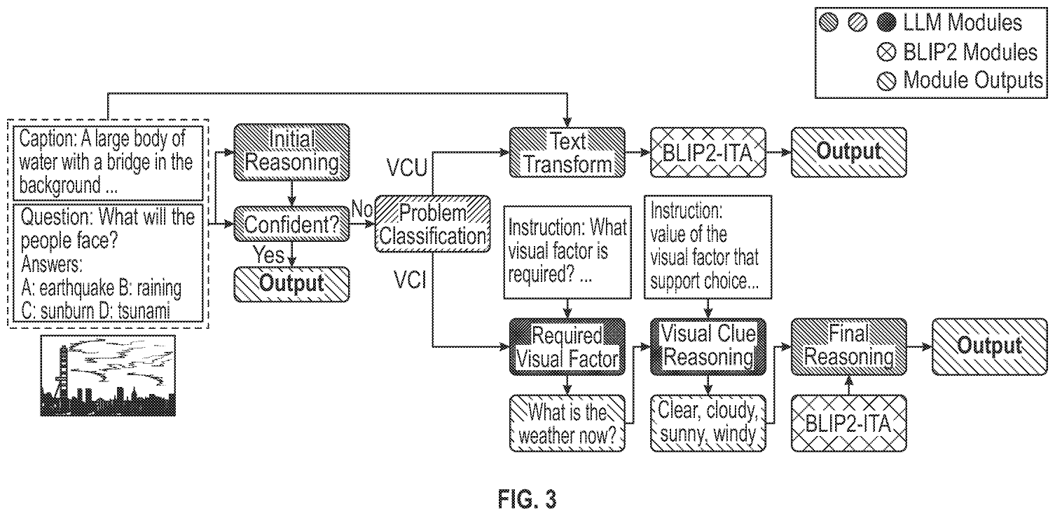

As shown in FIG. 3, the present system and method may involve a multi-step process. Initially, a pre-trained large language model (LLM) may first take the initial perception result (i.e., image caption), a question-answer pair, and instructions as input to evaluate potential answer candidates. Then, if the LLM is not confident about its initial reasoning, the LLM may reason about what visual factors may be perceived from the image to make a confident commonsense inference. Using this information as a guidance, a vision-and-language model (VLM) may focus on specific aspects of the image, returning the perception result back to the LLM. Finally, the LLM may re-evaluate the candidates in light of new perception results.

### 1. Large Language Models as VCR Reasoner

Evaluating answer choices, VCR may require drawing new conclusions based on commonsense knowledge. On the other hand, pre-trained VLMs may have a capability for visual understanding, including tasks such as image captioning and image-text alignment, with a demonstrated ability to generalize across various datasets. Therefore, the present system and method may harness the strengths of VLMs for visual understanding and the capabilities of LLMs for evaluating answer candidates in the context of visual commonsense reasoning. Captioning may serve as a fundamental unsupervised pre-training task and most generalized capabilities of pre-trained VLMs, which captures the most salient information from an image. Moreover, considering that text may serve as a universal interface for both VLMs and LLMs, employing image captions serves as an effective means to connect VLMs with LLMs without necessitating any model-specific fine-tuning. Therefore, the present system and method may first prompt the LLMs to take the caption of the image C, as the initial information and perform chain-of-thought reasoning on the question:

$${r}_{1} = LLM ( \{ {c}_{i} \} , q , {C}_{I} ) \qquad ( 3 )$$

The reasoning result r₁ may include both intermediate reasoning steps and the final answer. However, it may be important to note that the image caption may not encompass all the relevant information within the image, potentially omitting critical contextual details essential for answering the question. In such cases, it may become necessary to gather additional relevant visual observations from the image. Before this, the system and method may first judge whether there is a lack of supportive visual evidence that would allow it to make a confident decision. As in FIG. 3, the system and method may let the LLM take the initial reasoning r₁ and the history prompt as input to judge if current visual information adequately supports the decision. If it does, the model may directly output the result. Conversely, if there is a lack of sufficient evidence, the model may progress to the second stage, where it may seek additional visual evidence.

### 2. Large Language Models as VCR Problem Classifier

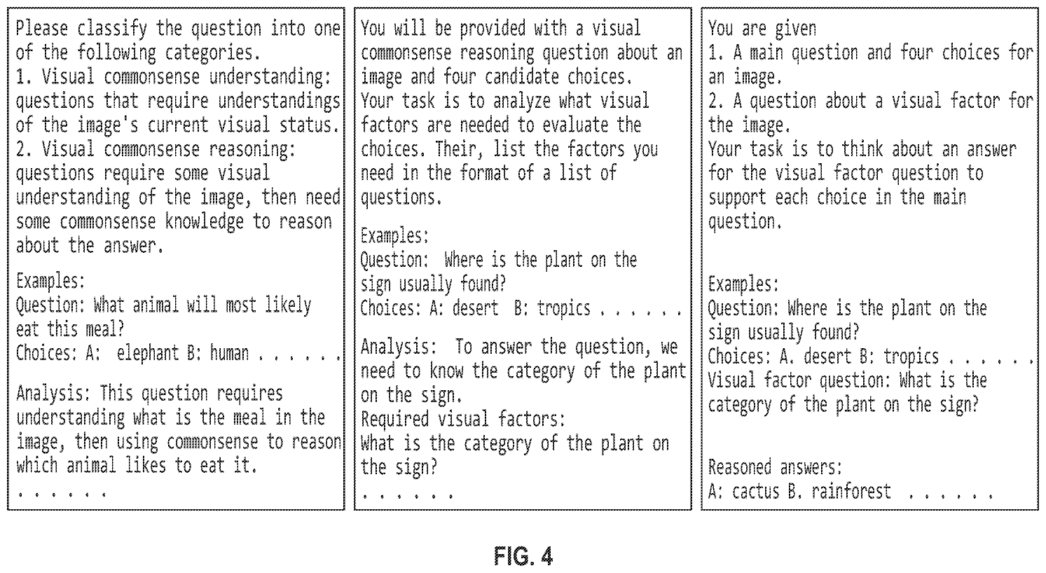

As defined in the last section, there may be two kinds of VCR problems, each requiring different levels of visual reasoning. Therefore, the present system and method may leverage VLMs in distinct manners when facing different problem types. To this end, the system and method may first prompt the LLM to classify the problem into two categories. To achieve this, the definitions of these two categories may be provided in the prompt. Additionally, a set of manually annotated in-context examples may be included to aid in problem classification, where the questions of in-context examples are selected from the training set. FIG. 4 may illustrate the prompt. FIG. 4 may show three simplified prompt examples demonstrating how prompts may be defined to classify the problem (left), reason visual factors (middle), and think about visual observations regarding visual factors (right).

### 3. Large Language Models as VLM Commander

A pre-training dataset of vision-and-language models may contain millions to billions of image-text pairs. Therefore, a hypothesis may be used that VLMs may have learned the mapping between visual features and the high-level commonsense concept during the pre-training. Thus, for visual commonsense understanding (VCU) problems, pretrained VLM may be leveraged by the LLM in a zero-shot manner. Specifically, for each choice cᵢ, the LLM may be instructed to transfer each choice cᵢ and an associated question to a declarative sentence with instruction and in-context examples, as shown:

$${s}_{i} = LL M ( q , {c}_{i} ) \qquad ( 4 )$$

For instance, for the question “What will the people face?” and the choice “earthquake”, the LLM may transform the question and the choice to “The people will face earthquake.” Then, sᵢ and the image I may be fed by the LLM to the pre-trained VLM to calculate the image-text alignment score. The sum of ITM and ITC scores may then be determined by the LLM to compare choices:

$${S}_{i} = ITM ( I , {s}_{i} ) + ITC ( I , {s}_{i} ) \qquad ( 5 )$$

The choice with the highest score may be taken or determined as the final output by the LLM.

For the VCI issues, the model may need to acquire related visual observations and use relevant commonsense knowledge to reason about the answer. This knowledge often neglected in the descriptions of the image. Therefore, as in FIGS. 3 and 4, the LLMs may evaluate some visual factors fⱼ that may influence the answer to the question, like “the action of the person”, “the interaction between people”, etc. Then, the visual observation of the visual factor in the image is acquired by the LLM with a visual question-answering model by asking a question about the visual factor:

$${o}_{j} = V QA ( I , {f}_{j} ) \qquad ( 6 )$$

wherein of may be the answer to the question, which may be a visual clue. However, although pre-trained VLMs have zero-shot visual question-answering (VQA) capabilities, VQA datasets may require human labeling and are not one of the pre-training tasks of VLMs. Therefore, the accuracy and the quality of zero-shot VQA may hinder the performance of the reasoning for the question. Furthermore, the answer of VQA may not consider the context of the main question and therefore may lack the most useful information. To this end, the LLM may be further prompted to reason about the potential instantiations of the visual factors that may support the choices as in FIG. 4:

$${o}_{ij} = LLM ( {f}_{j} , {c}_{i} , q ) \qquad ( 7 )$$

As an illustration, when fⱼ is “category of the plant,” the potential values for oᵢⱼ may include specific plant names like “cactus.” Then, the image-text matching (ITM) and image-text contrastive (ITC) functions of pre-trained VLMs may be leveraged to select the observation that most align with the image among the observations for each choice i:

$${o}_{j} = {o}_{jk} where k = {arg}_{i} max \{ ITM ( {o}_{ij , I} ) + ITC ( {o}_{ij} , I ) \} \qquad ( 8 )$$

Finally, we append the visual clues {oⱼ} after the caption as extra information for LLM to perform final reasoning:

$${r}_{2} = LLM ( \{ {c}_{i} \} , q , {C}_{I} , \{ {o}_{i} \} ) \qquad ( 9 )$$

### Experiments

### 1. Datasets

The present system and method using two datasets may be evaluated by focusing on visual commonsense reasoning: VCR and AOKVQA. Both datasets may formulate visual commonsense reasoning as 4-choice QA problems about an image, containing various visual commonsense understanding and inference problems. The VCR dataset may focus on human-centric visual commonsense reasoning problems. In contrast, A-OKVQA dataset may need various commonsense knowledge about common objects and events in daily life. For A-OKVQA, the validation set may be used with 1145 examples. For VCR dataset, 500/26534 examples may be randomly sampled from the validation set for evaluation, and the image may be divided from left to right into three bins and named by the person depending on which bin they are located in when feeding text to VLMs and LLMs. The performance of both datasets may be evaluated by accuracy.

### 2. Implementation Details

In testing the current system and method, GPT-3.5-turbo-0613 and GPT-4-0613 may have been used as the LLMs for reasoning. To ensure reproducibility, the temperature of the LLMs may be set to 0. For image captioning, LLAVA-7B-v1.1 may be employed. Furthermore, the pre-trained BLIP2 model may be used for image-text alignment and BLIP2-FlanT5 XL for visual question answering on both datasets. The number of in-context examples used in the prompts are shown in FIG. 4 is 6, 1, and 3 respectively.

### 3. Baselines

To demonstrate the effectiveness of the proposed framework, the following zero-shot baselines may be implemented, by the LLMs for example, for comparison:
BLIP2-Pretrain: The pre-trained BLIP-2 model may be used directly to perform image-text alignment on both datasets. On both datasets, GPT-3.5-turbo-0613 may be utilized to transform the questions and choices into declarative sentences and feed them to the BLIP-2 model to calculate the image-text alignment score. The choice with the highest alignment score may be selected as the answer.
IdealGPT: A concurrent method leveraging LLMs for visual reasoning. IdealGPT prompts LLMs to iteratively query a VQA model to answer questions for visual reasoning tasks, including VCR. In the present experiments, the original source code of IdealGPT may be employed while utilizing the same version of LLM and VLMs for caption, VQA, and reasoning as the present method.

### Results and Analysis

### 1. Ablation Study

Ablation studies on the present method may have been conducted on VCR and AOKVQA datasets. Results may be shown in FIG. 2.

### How do VLM and LLM Compare on Visual Commonsense Reasoning?

By comparing the first row and the third row in FIG. 2, the current method hypothesis on the comparison between VLM and LLM may be validated. It may be observed that, in VCU problems, the VLMs perform significantly better than LLM reasoning based on the caption on both datasets, with an average accuracy of 65.2% vs. 57.8%. While on VCI problems, LLM based on caption performs better on average at 56.3% vs. 50.0%. It may also be observed that BLIP2 has a significant performance gap between the two kinds of problems while LLM performs similarly. The significant difference between two models and two datasets also validates the effectiveness of the problem classification performed by LLM.

### How do Visual Factors and LLM Clue Reasoning Help Visual Commonsense Reasoning?

The effectiveness of visual factors reasoning and LLM clue reasoning on both BLIP2-Pretrain and LLM-based decision paradigms may be validated. Here, the adaptation of the clue generation method (as in Eq. 7) may be described for VCU: the LLM may be first prompted to generate the required visual factors, then generate visual clues oᵢⱼ of these factors that may support each choice. When applying the clues BLIP2-Pretrain, the average of the image-text alignment scores within the same choice may be taken or received as the image-text alignment score for the choice i:

$${S}_{i} = 1 / η \sum ( {ITM}_{J} ( I , {o}_{ij} ) + ITC ( I , {o}_{ij} ) ) \qquad ( 10 )$$

wherein η is the number of required visual factors determined by LLM. The choice with the highest score will be selected by LLM.

From Table 1, visual factors and visual clues are less helpful in VCU problems. On VCU problems, besides directly taking the concept being asked by the original question as the visual factor, the model may also consider low-level visual features as visual factors for the question. For example, for the question “What is the event in the image?”, and the choice “dinner”, the visual factor may be objects in the image, and the reasoned visual clues may be plates with food on the table.

On BLIP2-Pretrain, using clues for image-text alignment may not be as good as using the transferred declarative sentences. This validates that BLIP2 may already understand high-level concepts well.

However, introducing visual factors and observations as extra context may improve performance on LLM reasoning, especially when the LLM may not be confident about its initial judgment or reasoning, i.e., initial provided visual information (caption) may be insufficient. In this case, the performance of LLM reasoning (‘Cap+Clue’ in FIG. 2) may be comparable with pre-trained BLIP2. This may be because compared with BLIP2, LLM may also take caption as input and may implicitly combine the information from both caption and the visual clues.

For VCI problems, visual factors and visual clue generations may help both reasoning paradigms. First, the significant improvement in the BLIP2-Pretrain paradigm may validate that (1) pre-trained BLIP2 cannot well-align statements that goes beyond literal visual content, requiring commonsense inference; (2) LLM may reason about the visual factors that may contribute to supporting candidate commonsense inferences, and guide the VLM to focus on relevant factors accordingly.

Second, on LLM reasoning paradigm, the improvement of visual clue information may be more significant than on the VCU problems with 9.5% vs. 7.4%. This may show that VCI requires the perception of subtle details of the scene compared to VCU problems to make sense of the current situation, which may be harder to capture in a general caption. Third, visual clues reasoned by LLM may be better than VQA as the visual information provider. There are mainly two reasons. First, the pre-trained VLM sometimes may not understand or correctly answer the question due to the lack of language alignment. Second, the VQA model may lack the main question as the context and may not get the intention of the visual factor. Therefore, it may produce irrelevant answers. Examples to further illustrate these may be shown below.

How does Confidence Affect the Reasoning Process?

From FIG. 2, it is observed that when the LLM is confident about its initial reasoning, the performance may be better than BLIP2-Pretrain on both VCU and VCI problems. Second, combining more visual observations from VQA clue or LLM clue in these examples may hurt the performance most of the time. Therefore, including more information is unnecessary in this case.

### Results

### VCR

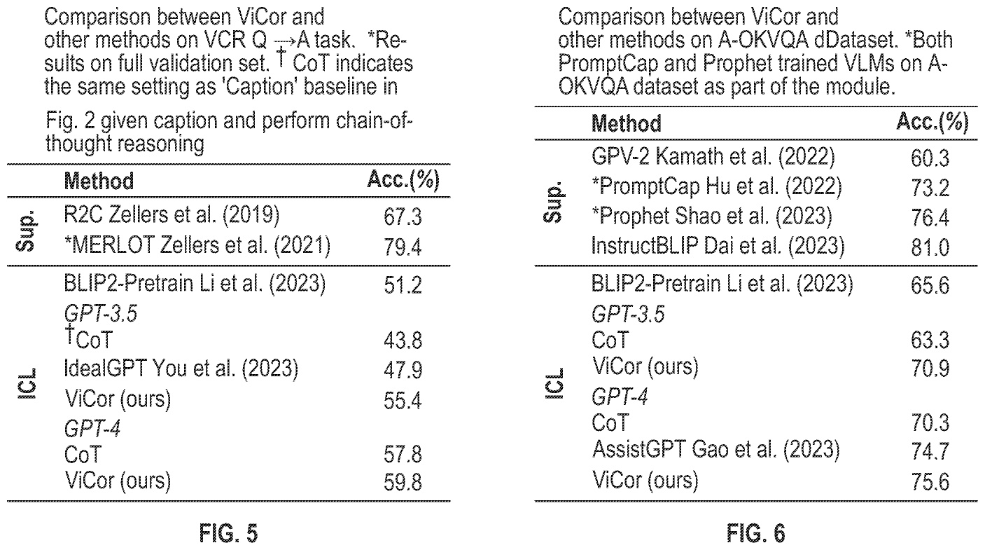

The results on VCR dataset may be shown in FIG. 5. The present method may achieve the best result compared with other methods without supervised training. Specifically, the present method may outperform the Ideal-GPT since it is able to leverage the visual recognition and understanding abilities of VLMs more effectively by considering the types and definitions of problems. However, it is noted that there is still a significant gap between ICL methods and methods with supervised training. This may be due to a loss of information in approximating the naming and labeling of the persons mentioned above.

### A-OKVQA

On A-OKVQA dataset shown in FIG. 6, on both GPT models, the present method may improve on chain-of-thought baseline by a significant margin. Compared with concurrent method AssistGPT, which utilizes GPT4 to call more visual tools such as object detection, text detection, and region grounding, the present method with only BLIP2 and LLAVA may achieve better results. Meanwhile, it is observed that the present method, without any training on the dataset, may achieve results close to the best supervised methods. This may show that an analysis and modeling for visual commonsense reasoning tackles the VCR problems more efficiently.

### Qualitative Examples

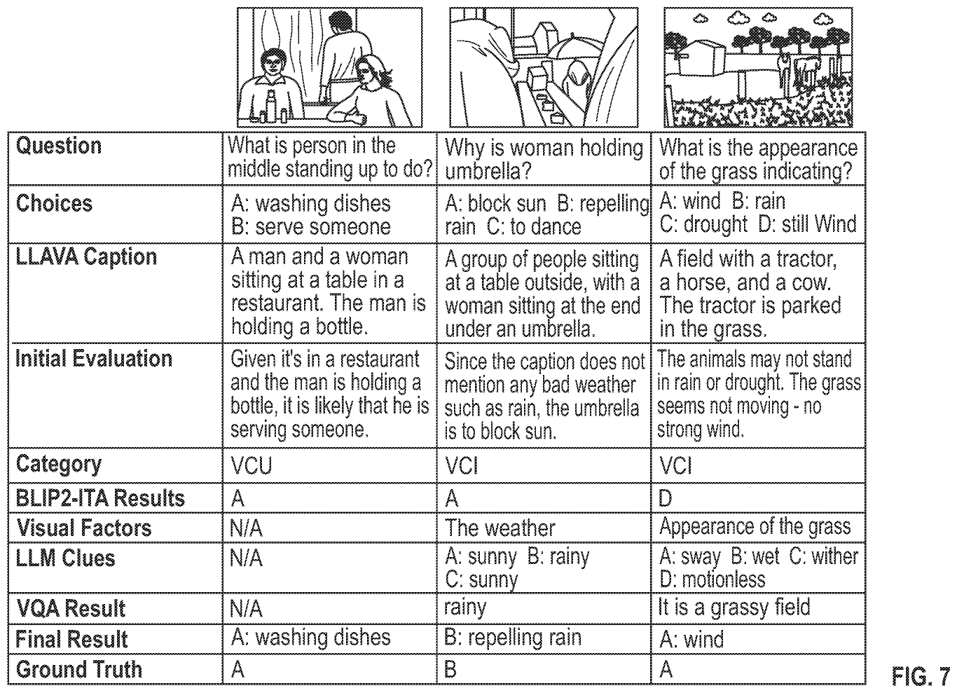

In FIG. 7, several qualitative examples may be demonstrated. The left example may show a case where the problem is classified as VCU, and the BLIP2-Pretrain may select the correct answer. The middle example may present a case where the initial evaluation is incorrect, and both the VQA and clue reasoning methods may give the correct observation for the visual factor ‘weather’, based on which the LLM selects the correct answer. The BLIP2-Pretrain here may select ‘block sun’ due to the lighting condition of the image. The example on the right may demonstrate a case when the LLM reasoned answer is better than the answer generated by the VQA model. Here, the VQA does not understand the intention of the visual factor without the context of the main question. The LLM reasoned answer, however, may provide the most relevant information to the question and help the final reasoning. The BLIP2-Pretrain may fail here due to the textual similarity between “wind” and “still wind”.

In this disclosure, the problem of visual commonsense reasoning (VCR) based on the capabilities of pre-trained vision-language models and large-language models and define two sub-problems—visual commonsense understanding (VCU) and visual commonsense inference (VCI) is studied. Based on this, it may be proposed that the present framework may efficiently use visual recognition and understanding capabilities of VLMs and commonsense reasoning capabilities of LLMs to overcome the challenges in VCR. The experiment results may validate the analysis of VCR problems and the effectiveness of the framework. Future work may explore fine-tuning approach with alternative mediums such as visual embeddings.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for visual commonsense reasoning (VCR) to infer information from an image, comprising:
separating a VCR matter into a visual commonsense understanding (VCU) matter and a visual commonsense inference (VCI) matter;
providing a visual content of the image using a VCU model; and
providing a conclusion, based on content of the image using a VCI model.

2. The method of claim 1, wherein the VCU model infers concepts from the image by recognizing visual patterns in the image and combining other data from the image.

3. The method of claim 2, wherein the concepts are one of actions, events, or relations in the image.

4. The method of claim 1, comprising:
using large language models (LLMs) as matter classifiers for the VCU matter and the VCI matter;
directing VLMs based on the matter classifiers using visual language models (VLMs) commanders; and
using pre-trained VLMs for visual recognition and understanding of the image.

5. The method of claim 4, wherein the pre-trained VLMs utilize image-text alignment (ITA) for visual recognition and understanding of the image.

6. The method of claim 4, wherein communication between LLMs and VLMs is through textual data.

7. The method of claim 1, comprising evaluating plausibility of an inference by evaluating the inference using non-visual commonsense knowledge to perform reasoning based on visual observations derived from the image by the VCI model.

8. The method of claim 7, comprising:
using large language models (LLMs) to perform initial perception result of a plausibility of the inference;
performing problem classification by the LLMs; and
acquiring visual information according to the problem classification by the LLMs if the initial perception result of the inference is below a predetermined level.

9. The method of claim 7, comprising:
performing an initial perception result of a plausibility of the inference using large language models (LLMs), wherein the LLMs takes the initial perception result of the inference as an input to evaluate potential answer candidates when the initial perception result of the inference is below a predetermined level;
forming a commonsense inference when the initial perception result of the inference is below a predetermined level using visual factors from the image by the LLMs;
forming a new perception result using a vision-and-language model (VLM);
returning the new perception result back to the LLM; and
re-evaluation of the potential answer candidates by the LLM based on the new perception results.

10. The method of claim 9, comprising outputting a result by the LLM when current visual information supports the potential answer candidates.

11. A method for visual commonsense reasoning (VCR) to infer information from an image, the method implemented using a control system including a processor communicatively coupled to a memory device, the method comprising:
separating a VCR matter into a visual commonsense understanding (VCU) matter and a visual commonsense inference (VCI) matter
providing a visual content of the image using a VCU model, wherein the VCU model infers concepts of the image by recognizing visual patterns in the image and combines other data from the image to infer the concepts from the image;
providing conclusions based on content of the image using a VCI model;
using large language models (LLMs) as matter classifiers for the VCU matter and the VCI matter;
directing VLMs based on the matter classifiers using visual language models (VLMs) commanders; and
using pre-trained VLMs for visual recognition and understanding of the image.

12. The method of claim 11, wherein the concepts are one of actions, events, or relations in the image.

13. The method of claim 11, wherein the pre-trained VLMs utilized image-text alignment (ITA) for visual recognition and understanding of the image.

14. The method of claim 11, wherein communication between LLMs and VLMs is through textual data.

15. The method of claim 11, comprising:
performing an initial perception result of a plausibility of the inference using LLMs, wherein the LLMs takes the initial perception result of the inference as an input to evaluate potential answer candidates when the initial perception result of the inference is below a predetermined level;
forming a commonsense inference when the initial perception result of the inference is below a predetermined level using visual factors from the image by the LLMs;
forming a new perception result using a vision-and-language model (VLM);
returning the new perception result back to the LLM; and
re-evaluation of the potential answer candidates by the LLM based on the new perception results.

16. The method of claim 15, comprising outputting a result by the LLM when current visual information supports the potential answer candidates.

17. A method for visual commonsense reasoning (VCR) to infer information from an image, comprising:
separating a VCR matter into a visual commonsense understanding (VCU) matter and a visual commonsense inference (VCI) matter;
providing a visual content of the image using a VCU model, wherein the VCU model infers concepts of the image by recognizing visual patterns in the image and combines characteristics and particulars from the image to infer the concepts from the image;
providing conclusions based on content of the image using a VCI model;
evaluating plausibility of an inference by evaluating the inference using non-visual commonsense knowledge to perform reasoning based on visual observations derived from the image by the VCI model;
forming an initial perception result of a plausibility of the inference using large language models (LLMs), wherein the LLMs takes the initial perception result of the inference as an input to evaluate potential answer candidates when the initial perception result of the inference is below a predetermined level;
forming a commonsense inference using visual factors from the image by the LLM when the initial perception result of the inference is below a predetermined level;
forming a new perception result using a vision-and-language model (VLM);
returning the new perception result back to the LLM; and
re-evaluation of the potential answer candidates by the LLM based on the new perception results.

18. The method of claim 17, wherein the concepts are one of actions, events, or relations in the image.

19. The method of claim 17, wherein the pre-trained VLMs utilize image-text alignment (ITA) for visual recognition and understanding of the image.

20. The method of claim 17, comprising outputting a result by the LLM when current visual information supports the potential answer candidates.
